(19) United States
(12) Patent Application Publication
(10) Pub. No.: US 2004/0064751 A1
(43) Pub. Date: Apr. 1, 2004

(54) System and method for switching clock sources

(76) Inventor: Edward Anglada, Aguadilla, PR (US)

Correspondence Address: HEWLETT-PACKARD COMPANY, Intellectual Property Adminstration, P.O Box 272400, Fort Collins, CO, 80527-2400, US

(21) Appl. No.: 10/259,055

(22) Filed: Sep. 27, 2002

(51) Int. Cl. G06F 1/04

(52) U.S. Cl. 713/500; 713/600

(57) ABSTRACT

A system and method for switching clock sources is presented. One embodiment of the system comprises a main clock and removable card having normally unused pins. The removable card is configured to host a secondary clock. This embodiment of the system further comprises a clock-selection circuit configured to determine whether or not the removable card is hosting the secondary clock. If the clock-selection circuit determines that the removable card is hosting the secondary clock, then the clock-selection circuit selects the secondary clock and the signal from the secondary clock is relayed through the unused pins. If, on the other hand, the clock-selection circuit determines that the removable card is not hosting the secondary clock, then the clock-selection circuit selects the main clock.

### BACKGROUND

In many computer systems, a maximum operational clock frequency of an electronic circuit is dictated by critical paths, which are circuit paths where combinational delays are greater than the time allocated for data transmission at the operational clock frequency. Critical paths may be identified using an iterative process in which a known input data is supplied to a processor at various operational clock frequencies. An actual output data of the processor is compared with an expected output data for each of the various operational clock frequencies. If there is no discrepancy between the actual output data and the expected output data for a given operational clock frequency, then it may be concluded that the maximum operational clock frequency has not been exceeded.

Similarly, the operating margin of various electronic assemblies may be tested by varying the operational clock frequency. Thus, for example, an electronic assembly manufacturer may increase or decrease the operational clock frequency in order to determine whether or not a system is susceptible to errors due to fluctuations in operational clock frequencies.

In some instances, the operational clock frequency is changed by physically replacing a main clock with a substitute clock. However, this approach is undesirable because it may compromise the integrity of the electronic assembly that is being tested.

In other instances, the operational clock frequency is changed by adding a physical socket for a substitute clock and a hardware switch to the electronic assembly. In situations where the physical socket and the hardware switch are added, the setting of the hardware switch would determine whether the main clock or the substitute clock controlled the operational clock frequency. This approach, however, requires the permanent adding of extra hardware on each electronic assembly, which translates to an added cost for each electronic assembly.

In view of these deficiencies, a heretofore-unaddressed need exists in the industry.

### SUMMARY

The present disclosure provides clock source switching systems and methods.

Briefly described, in architecture, one embodiment of the system comprises a main clock configured to generate a main clock signal. In this embodiment, the system further comprises a removable card having unused pins. The removable card is configured to host a secondary clock. Thus, when a secondary clock is hosted on the removable card, the signal from the secondary clock is relayed through one of the unused pins. In this embodiment, the system further comprises a clock-selection circuit, which detects whether or not the removable card is hosting the secondary clock. If the clock-selection circuit detects that the removable card is hosting the secondary clock, then the clock-selection circuit generates a secondary-clock-select signal. If, on the other hand, the clock-selection circuit does not detect that the removable card is hosting the secondary clock, then the clock-selection circuit generates a main-clock-select signal.

The disclosure also provides clock source switching methods. In this regard, one embodiment of the method operates within an electronic assembly having a main clock. In this embodiment, the method comprises the step of detecting a secondary clock installed on a removable card having unused pins. Additionally, in this embodiment, the method comprises the step of selecting the secondary clock in response to detecting the secondary clock.

### BRIEF DESCRIPTION OF THE DRAWINGS

The components in the following drawings are not necessarily to scale.

FIG. 1 is a block diagram of a computer system having an electronic assembly with a main clock.

FIG. 2 is a block diagram showing a removable card of the electronic assembly of FIG. 1.

FIGS. 3A and 3B are block diagrams showing an electronic assembly with a clock-selection circuit configured to select between two clocks.

FIG. 4 is a block diagram showing the secondary clock of FIGS. 3A and 3B located on the removable card.

FIGS. 5A and 5B are flowcharts showing several embodiments of a clock source switching method, which may be implemented by the removable card of FIGS. 3A and 3B.

FIG. 6 is a flowchart showing another embodiment of the method, which may be implemented by the clock-selection circuit of FIGS. 3A and 3B.

### DETAILED DESCRIPTION

Reference is now made in detail to the description of a representative embodiments as illustrated in the drawings. As shown below, several embodiments are presented in which a main clock source is bypassed using a secondary clock source that is on a removable card having unused pins. The embodiments permit the switching of clock sources without physically replacing the main clock source on a system board.

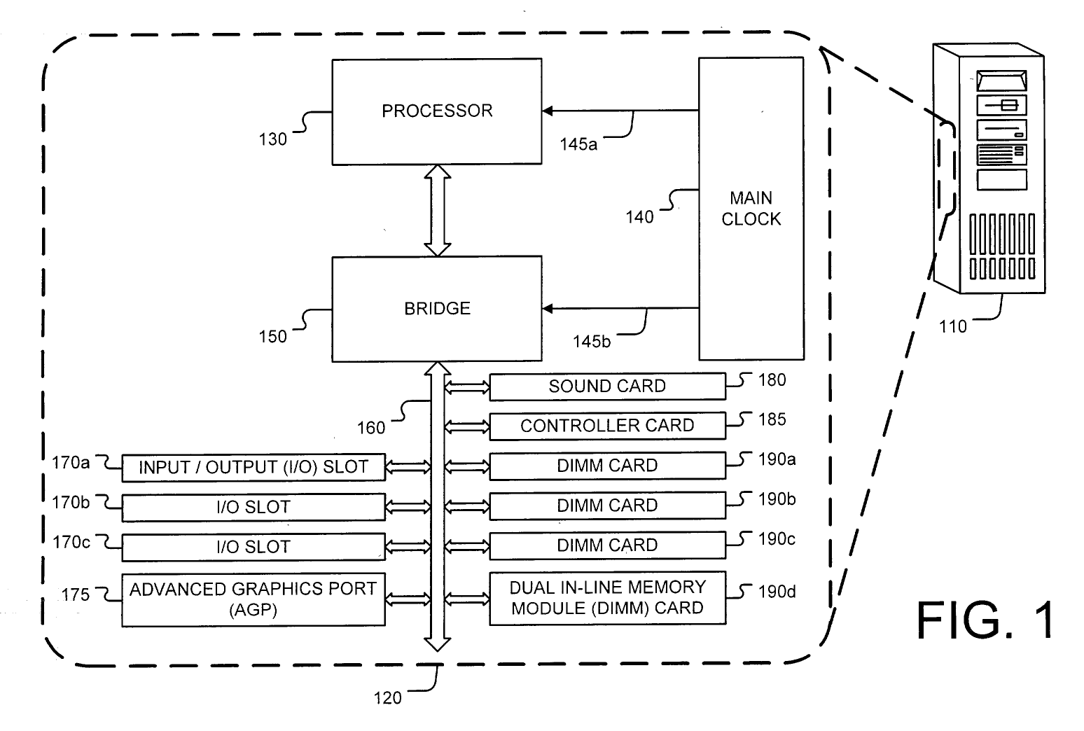

In an electronic assembly 120, similar to the one shown in FIG. 1, the operational clock frequency is often changed by physically replacing a main clock 140 with a substitute clock. Such an electronic assembly 120 includes a processor 130 that is configured to control the operation of the electronic assembly 120, a bridge 150 that is interposed between the processor 130 and other peripheral components. Typically, one or more buses 160 permit communication between the main clock 140, the processor 130, the bridge 150, and the other peripheral components. These peripheral components often assist the processor 130 in improving the performance of the electronic assembly 120. As such, the peripheral components usually include several removable cards such as dual in-line memory module (DIMM) cards 190a, 190b, 190c, 190d, a controller card 185, a sound card 180, etc. In addition to these removable cards, the electronic assembly 120 sometimes includes several input/output (I/O) slots 170a, 170b, 170c, an advanced graphics port (AGP) slot 175, and various other slots for the addition of other external peripheral components. All of these components also interface to one or more buses 160, thereby permitting communication to the processor 130 through the bridge 150. The main clock 140 on the electronic assembly 120 supplies main clock signals 145a and 145b to the processor 130 and the bridge 150, respectively, thereby permitting proper operation of the electronic assembly 120.

As shown in FIG. 1, since only one main clock 140 resides on the electronic assembly 120, the critical paths of the electronic assembly 120 can only be tested at the frequency of the main clock 140 unless the main clock 140 is replaced by another clock. Thus, in order to test critical paths within the electronic assembly 120, the main clock 140 is often physically replaced by another clock having a different operational frequency. However, the physical replacement of the main clock 140 is undesirable because it may compromise the integrity of the electronic assembly 120 that is being tested.

In other instances, rather than physically replacing the main clock 140, the operational clock frequency is changed by adding a physical socket for a substitute clock and a hardware switch to the electronic assembly 120. In situations where the physical socket and the hardware switch are added, the setting of the hardware switch would determine whether the main clock 140 or the substitute clock controlled the operational clock frequency. This approach, however, requires the permanent adding of extra hardware on each electronic assembly, which translates to an added cost for each electronic assembly.

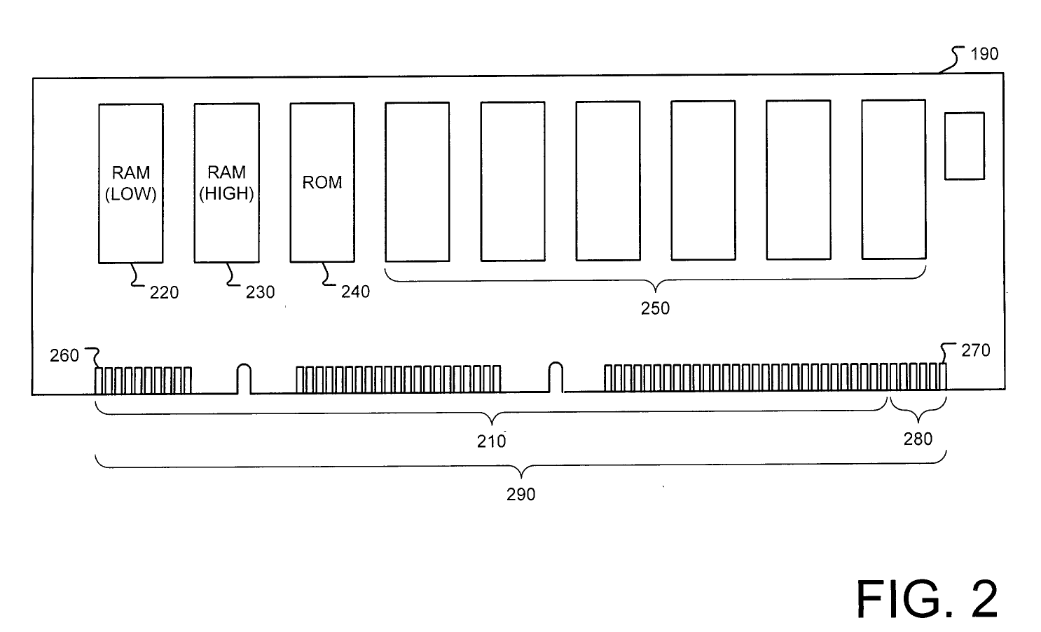

FIG. 2 is a block diagram showing a removable card from the electronic assembly 120 of FIG. 1. In the specific example of FIG. 2, the removable card is a DIMM card 190 having random-access memory (RAM) chips 220, 230, a read-only memory (ROM) chip 240, and a plurality of other available apertures 250 that are configured to host additional memory chips. As shown in FIG. 2, the DIMM card 190 further comprises a plurality of pins 290, which are configured to provide electrical coupling of the components on the DIMM card 190 to the bus 160 of the electronic assembly 120. Due to the overabundance of pins 290 on the removable DIMM card 190, only some of the pins 210 (hereinafter also referred to as used pins) provide electrical connections to the RAM chips 220, 230 and the ROM chip 240. The other pins 280 (hereinafter also referred to as unused pins) are not used by the DIMM card 190.

The DIMM card 190 having N pins 290 is arranged from pin 1 to pin N, with each used pin 210 designated to supply a specific signal to and from the DIMM card 190. For example, at least one of the used pins is configured to carry the supply voltage VDD to the DIMM card 190 while at least one of the pins is configured to supply the ground node GND on the DIMM card 190. Since specific pin configurations are known in the art, further discussion of pin configurations is omitted here. In any event, as seen in FIG. 2, the DIMM card 190 may have several unused pins 280, which are not configured for any function on the DIMM card 190. These unused pins 280 occupy space on the DIMM card 190 while serving no function on the DIMM card 190, thereby wasting valuable space.

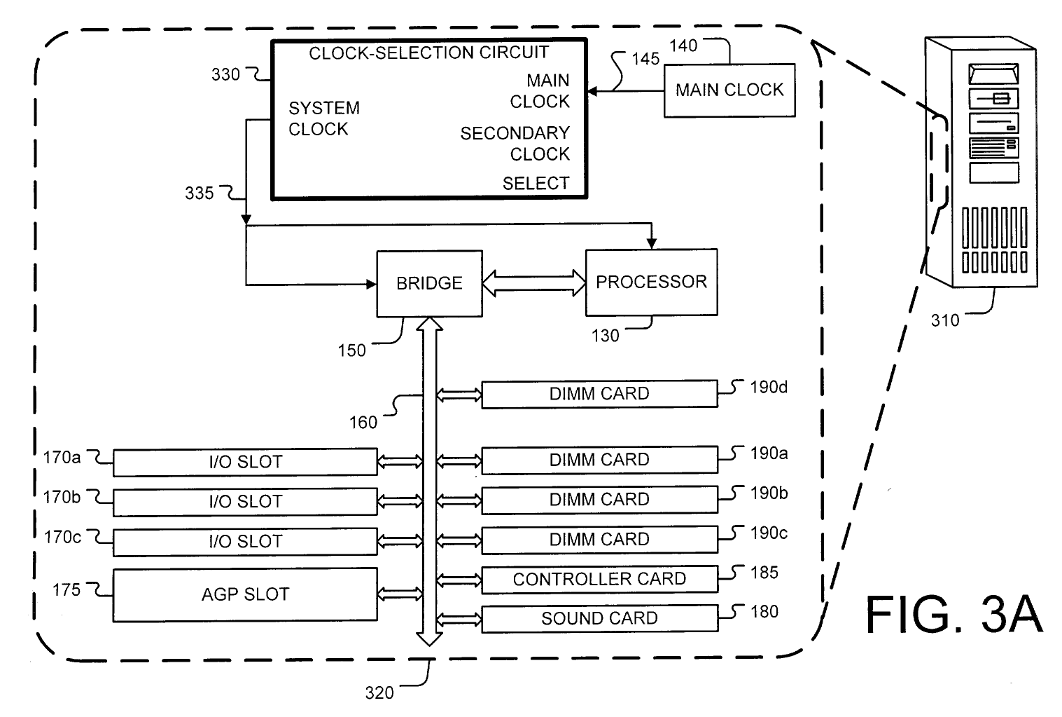

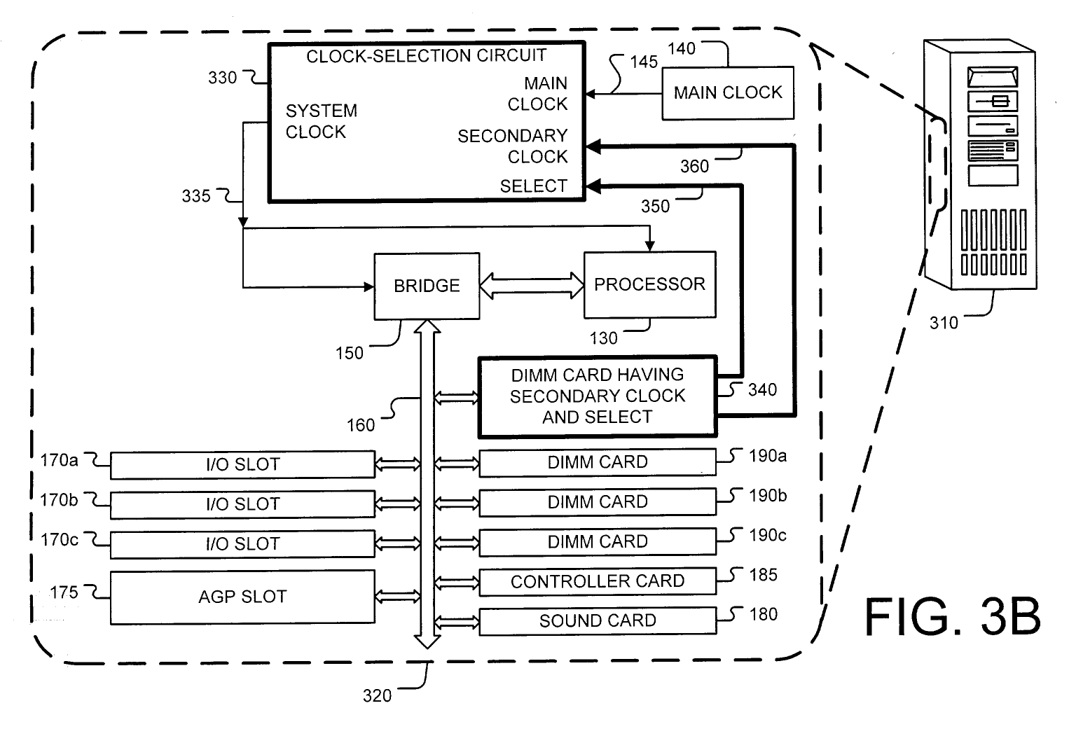

FIGS. 3A and 3B are block diagrams showing an electronic assembly 320 with a clock-selection circuit 330 configured to select between two clocks. FIG. 3A is a block diagram showing an electronic assembly 320 with a main clock 140 and a removable card 190d that does not have a secondary clock or a clock select. FIG. 3B is a block diagram showing an electronic assembly 320 with a main clock 140 and a removable card 340 having a secondary clock and a clock select.

As shown in FIG. 3A, an electronic assembly 320 includes a processor 130, which is configured to control the operation of the electronic assembly 320. In addition to the processor 130, the electronic assembly 320 also includes a bridge 150, which is interposed between the processor 130 and other peripheral components through a bus 160. These peripheral components may assist the processor 130 in improving the performance of the electronic assembly 320. As such, the peripheral components include several removable cards such as DIMM cards 190a, 190b, 190c, 190d, a controller card 185, a sound card 180, etc. In the embodiment of FIG. 3A, a secondary clock is not present within the electronic assembly.

In addition to these removable cards, the electronic assembly 320 may include several input/output (I/O) slots 170a, 170b, 170c, an advanced graphics port (AGP) slot 175, etc. for the addition of other external peripheral components. All of these components interface to a bus 160, which permits communication between the processor 130 and the peripheral devices through the bridge 150.

The electronic assembly 320 further comprises a main clock 140 coupled to a clock-selection circuit 330. The clock-selection circuit 330 is configured to detect either the presence or the absence of a secondary clock, and select a system clock as a function of either the presence or absence of the secondary clock. As such, the clock-selection circuit 330 is further configured to receive the main clock signal 145, a secondary clock signal (not shown), and a clock-select signal (not shown). Depending on the value of the clock-select signal (not shown), the clock-selection circuit 330 selects either the main clock signal 145 as a system clock signal 335, or, alternatively, selects the secondary clock signal (not shown) as the system clock signal 335.

As seen in FIG. 3A, there is no secondary clock source in the electronic assembly 320. Thus, in the embodiment of FIG. 3A, the main clock 140 governs the timing of the entire electronic assembly 320. The main clock signal 145 is relayed to the processor 130 and the bridge 150 through the clock-selection circuit 330, which is configured to receive the main clock signal 145 at all times regardless of whether or not a secondary clock is present within the electronic assembly 320. In the embodiment of FIG. 3A, in the absence of the secondary clock signal (not shown) and the clock-select signal (not shown), the clock-selection circuit 330 selects the main clock signal 145 as the default system clock signal 335. A different result occurs, however, when a secondary clock is present within the electronic assembly 320, as shown in FIG. 3B.

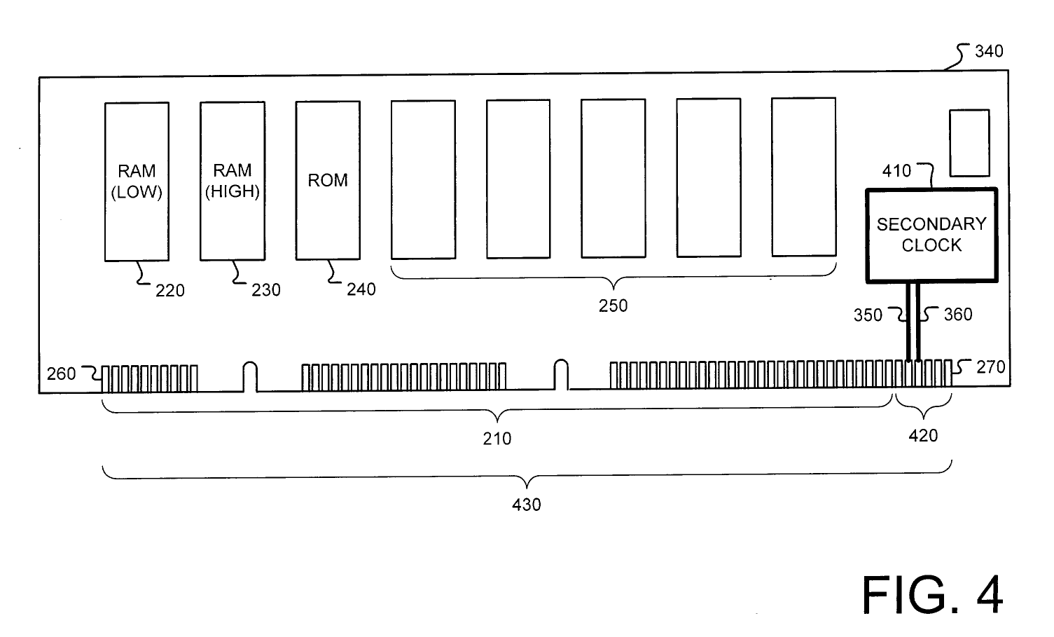

In the embodiment of FIG. 3B, the electronic assembly 320 includes a processor 130, which is configured to control the operation of the electronic assembly 320. In addition to the processor 130, the electronic assembly 320 also includes a bridge 150, which is interposed between the processor 130 and other peripheral components through a bus 160. Similar to FIG. 3A, these peripheral components may assist the processor 130 in improving the performance of the electronic assembly 320. As such, the peripheral components include several removable cards such as DIMM cards 190a, 190b, 190c, a controller card 185, a sound card 180, etc. Also, the embodiment of FIG. 3B includes a removable card 340 that provides a secondary clock signal 360 and a clock-select signal 350. This is shown in greater detail in FIG. 4. The secondary clock signal 360 and the clock-select signal 350 on the removable card 340 allow testing of the electronic assembly 320 at various clock speeds. In the specific embodiment of FIG. 3B, the removable card 340 is shown as a DIMM, card 340 configured to generate the secondary clock signal 360 and the clock-select signal 350. However, the secondary clock signal 360 and the clock-select signal 350 may be generated by any type of removable card, such as the controller card 185, the sound card 180, or a variety of other removable cards.

In addition to these removable cards, the electronic assembly 320 may include several I/O slots 170a, 170b, 170c, an AGP slot 175, and a variety of other slots for the addition of other external peripheral components. All of these removable cards and components interface to a bus 160, which permits communication to the processor 130 through the bridge 150.

The electronic assembly 320 further comprises a main clock 140 coupled to a clock-selection circuit 330. As such, the clock-selection circuit 330 comprises a MAIN CLOCK input and a SYSTEM CLOCK output, which are configured to receive the main clock signal 145 and output a system clock signal 335, respectively. Additionally, the clock-selection circuit 330 comprises a SECONDARY CLOCK input and a SELECT input, which are described below. The clock-selection circuit 330 is configured to detect either the presence or the absence of the secondary clock, and select a system clock as a function of either the presence or the absence of the secondary clock. In a representative embodiment, the presence or absence of the secondary clock is detected automatically as a function of the SELECT input to the clock-selection circuit 330. For example, if there is no secondary clock present in the electronic assembly 320 (i.e., the secondary clock is absent from the electronic assembly), then there will be no signal entering the SELECT input of the clock-selection circuit 330. Thus, the SELECT input is driven low (e.g., binary “0”) in the absence of the secondary clock. When the SELECT input is driven low, the clock-selection circuit 330 selects the main clock as the system clock and merely propagates the main clock signal 145 to the SYSTEM CLOCK output, thereby setting the main clock signal 145 as the system clock signal 335.

If a secondary clock is present on a removable card 340 as shown in FIG. 3B, then the secondary clock on the removable card 340 generates a secondary clock signal 360 and a clock-select signal 350, which are input to the SECONDARY CLOCK input and the SELECT input of the clock-selection circuit 330, respectively. In a representative embodiment, the clock-select signal 350 is simply a binary “1” or a high signal. Once the clock-select signal 350 is input to the SELECT input of clock-selection circuit 330, the SELECT input is driven high (e.g., binary “1”) and the clock-selection circuit 330 selects the secondary clock as the system clock. The secondary clock signal 360 is propagated to the SYSTEM CLOCK output, thereby setting the secondary clock signal 360 as the system clock signal 335.

While there are several different ways of implementing a clock-selection circuit 330, in a representative embodiment the clock-selection circuit 330 is implemented as a phase-locked loop (PLL) circuit. The PLL circuit is configured to receive two clock signals (e.g., a main clock signal 145 and a secondary clock signal 360) and a clock-select signal 350. Upon receiving the main clock signal 145 and the secondary clock signal 360, the PLL circuit selects one of the two clock signals as the system clock, depending on the value of the clock-select signal 350.

In another embodiment, the clock-selection circuit 330 may be implemented using a two-input-one-output (2×1) multiplexer (MUX) having a select input. In this sense, each of two clock signals (e.g., a main clock signal 145 and a secondary clock signal 360) are input to each of the two MUX inputs, and the clock-select signal 350 is input to the select input of the MUX. Thereafter, one of the clock signals is output at the MUX output depending on the value of the clock-select signal 350. Other similar circuits may be used as the clock-selection circuit 330 if the circuits are capable of (1) receiving at least two clock signals, (2) selecting one of the received clock signals, and (3) outputting the selected clock signal.

FIG. 4 is a block diagram showing the secondary clock 410 of FIGS. 3A and 3B located on the removable card 340. In the specific embodiment of FIG. 4, the removable card 340 is a DIMM card 340 having random-access memory (RAM) chips 220, 230, a read-only memory (ROM) chip 240, and a plurality of other available apertures 250, which are configured to host additional memory chips. As shown in FIG. 4, the DIMM card 340 further comprises a plurality of pins 430 that are configured to provide electrical coupling of the components on the DIMM card 340 to the bus 160 of the electronic assembly 120. Due to the typical overabundance of pins 430 on the removable DIMM card 340, only certain pins 210 provide electrical connections to the RAM chips 220, 230 and the ROM chip 240. The previously unused pins 420 are not used by the RAM chips 220, 230 or the ROM chip 240 on the DIMM card 340.

Unlike the DIMM card 190 of FIG. 1, the DIMM card 340 of FIG. 4 includes a secondary clock 410, which is configured to generate a secondary clock signal 360 and a clock-select signal 350. Since the RAM chips 220, 230 and the ROM chip 240 did not exhaust the available pins 430 on the DIMM card 340, the secondary clock signal 360 and the clock-select signal 350 are conveyed from the DIMM card 340 using any one of the previously unused pins 420. As is known in the art, the DIMM card 340 having N pins 430 is arranged from pin 1 to pin N with each used pin 210 designated for a specific signal transmitted to and received from the DIMM card 340. At least (one of the used pins is configured to carry the supply voltage VDD to the DIMM card 340 while at least one of the pins is configured to supply the ground node GND on the DIMM card 340. Since, in a representative embodiment, the clock-select signal 350 is a binary “1” or a high signal, the pin used for the clock-select signal 350 may simply be short-circuited to VDD. Alternatively, the secondary clock 410 may be configured to generate a separate clock-select signal 350. In either case, the DIMM card 340 may be used to host the secondary clock 410 and generate the clock-select signal 350 if the RAM chips 220, 230 and the ROM chip 240 do not exhaust the pins 430 on the DIMM card 340.

As seen in the system of FIGS. 3A, 3B, and 4, by utilizing previously unused pins 420 on a DIMM card 340, a secondary clock 410 may be added to the electronic assembly 320 without compromising the integrity of the electronic assembly 320. While the specific embodiments of FIGS. 3A, 3B, and 4 show the secondary clock 410 hosted on a DIMM card 340, the secondary clock 410 may be hosted on any removable card (e.g., controller card, sound card, etc.), so long as the pre-existing circuit components on the removable card do not exhaust all of the pins on the removable card.

By “piggy-backing” the secondary clock 410 onto a removable card 340, the need for additional sockets or additional ports is eliminated. Thus, for electronic assemblies 320 in a dense computer system with very little room for additional components, the mounting of the secondary clock 410 onto a pre-existing removable card 340 permits clock source switching without adding sockets or ports for external clocks. Furthermore, in a representative embodiment, the clock-select signal 350 is automatically input to the clock-selection circuit 330 upon insertion of the removable card 340. Thus, there is no need for additional switches for clock selection. In other words, the simple insertion of the removable card 340 indicates to the clock-selection circuit 330 that the secondary clock 410 is present, thereby automatically selecting the secondary clock 410 over the main clock 140.

Additionally, since the clock-selection circuit 330 may be implemented using a simple PLL or a 2×1 MUX, very little additional hardware is needed on the electronic assembly 320. For example, if a 2×1 MUX is used as the clock-selection circuit 330, then the 2×1 MUX would be interposed between the main clock 140 and the processor 130 and bridge 150, and only a pair of jumpers would be needed to connect the previously unused pins 420 of the removable card 340 to the other inputs of the 2×1 MUX.

Furthermore, since the secondary clock 410 is hosted on a removable card 340, the operating margin of the components on the electronic assembly 320 may be tested using the removable card 340 having the secondary clock 410. Once the testing is complete, the actual product may be shipped without the secondary clock 410 by removing the removable card 340 having the secondary clock 410 and inserting a standard DIMM card 190d or other standard removable card as shown in FIG. 1.

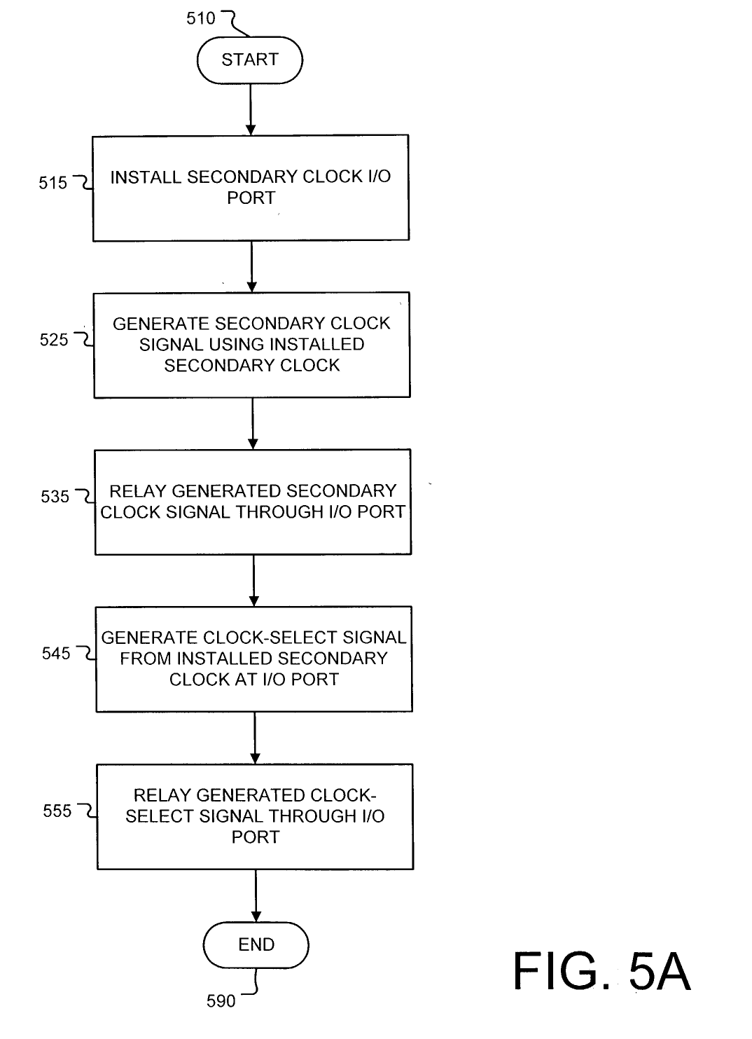

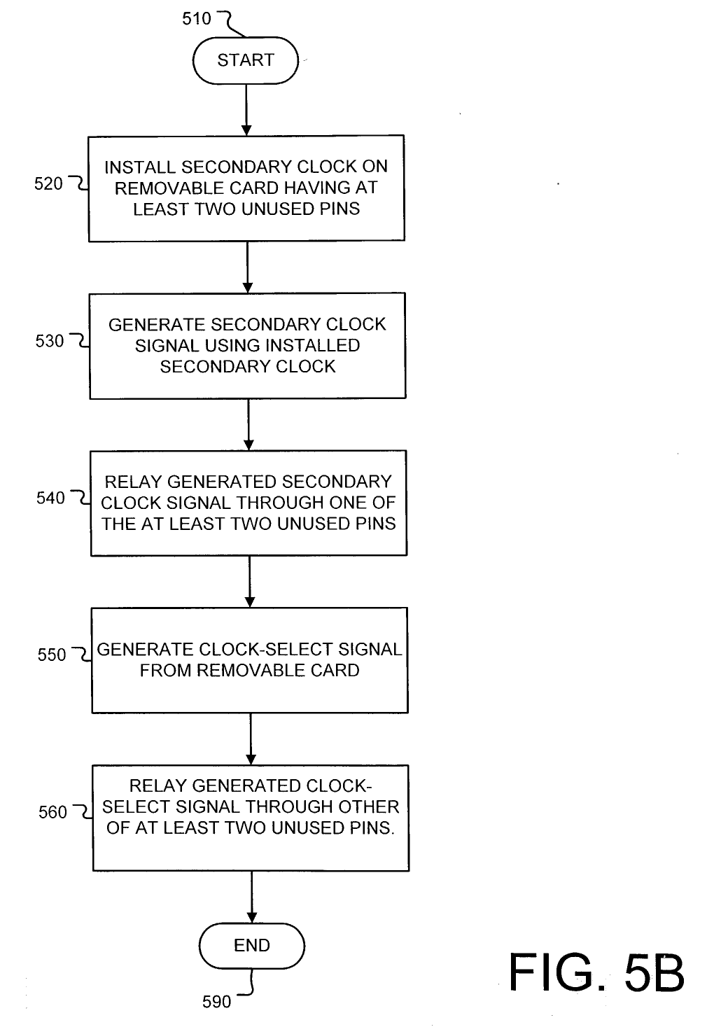

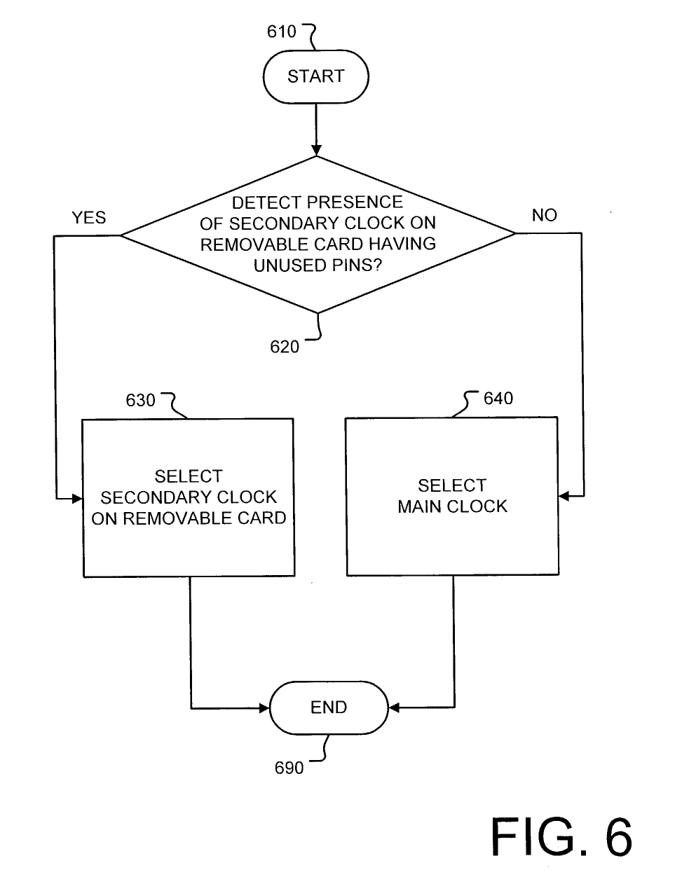

Having described several embodiments of a clock source switching system, attention is turned to FIGS. 5A, 5B, and 6, which describe several embodiments of methods for clock source switching.

FIGS. 5A and 5B are flowcharts showing several embodiments of a clock source switching method. As shown in FIG. 5A, one embodiment of the method begins with installing (515) a secondary clock 410 at an I/O port. Upon installing the secondary clock 410 at the I/O port, a secondary clock signal 360 is generated (525) using the installed secondary clock 410. The generated secondary clock signal 360 is then relayed (535) to the clock-select circuit 330 through the I/O port. In addition to generating the secondary clock signal 360, a clock-select signal 350 is generated (545) from the installed secondary clock 410, and relayed (555) to the clock-selection circuit 330 through the I/O port. In the method of FIG. 5A, a switch would be implemented in order to notify the system of the installed secondary clock 410 at the I/O port. Alternatively, the method of FIG. 5A may be implemented in any removable card in which at least two pins are not being used.

FIG. 5B illustrates the embodiment using the removable card. In FIG. 5B, the process begins with installing (520) a secondary clock 410 onto a removable card 340 (e.g., a DIMM card, a sound card, a controller card, etc.) having at least two unused pins. Since a secondary clock signal 360 and a clock-select signal 350 are generated from the removable card 340, the removable card 340 would need at least one pin for relaying the clock-select signal 350 and another pin for relaying the secondary clock signal 360. Upon installing the secondary clock 410 on the removable card 340, a secondary clock signal 360 is generated (530) using the installed secondary clock 410. The generated secondary clock signal 360 is then relayed (540) to the clock-select circuit 330 through one of the previously unused pins 420. In addition to generating the secondary clock signal 360, a clock-select signal 350 is generated (550) from the removable card 340 itself. In this sense, the removable card 340 may be configured to short circuit the VDD pin with the clock-select pin, thereby supplying a binary “1” as the clock-select signal 350. The generated clock-select signal 350 is then relayed (560) to the clock-selection circuit 330 using another previously unused pin 420. The method of FIG. 5B may be implemented in a DIMM card 340 similar to the one shown in FIG. 4. Alternatively, the method of FIG. 5B may be implemented in any removable card having at least two unused pins.

FIG. 6 is a flowchart showing another embodiment of the method, which may be implemented by the clock-selection circuit 330. As shown in FIG. 6, this embodiment begins with detecting (620) the presence (or absence) of a secondary clock 410 on a removable card 340 having unused pins 420. As described with reference to FIGS. 3A, 3B, and 4, the presence (or absence) of the secondary clock 410 may be detected by determining whether or not a clock-select signal 350 is generated by the removable card 340. If the presence of a secondary clock 410 is detected on the removable card 340, then the secondary clock 410 on the removable card 340 is selected (630) as the system clock. If, however, the presence of a secondary clock 410 is not detected on the removable card 340, then a main clock 140 is selected (640) as the system clock. In a representative embodiment, the method of FIG. 6 may be implemented using the clock-selection circuit 330. However, in other embodiments, the method of FIG. 6 may be implemented using any number of circuits that are configured to detect the presence of a secondary clock 410 on a removable card 340.

The clock-selection circuit 330 may be implemented in hardware using any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts may represent modules, segments, or portions of code which include one or more executable instructions for implementing specific logical functions or steps in the disclosed processes. These functions or steps may be executed out of order from that shown or discussed, including substantially concurrently or in reverse order, depending on the functionality involved.

Although exemplary embodiments have been shown and described, it will be apparent that a number of changes, modifications, or alterations may be made. All such changes, modifications, and alterations should therefore be seen as being within the scope of the present invention.

What is claimed is:

1. A clock source switching system comprising:
a main clock configured to generate a main clock signal;
a removable card having unused pins;
a secondary clock configured to generate a secondary clock signal, the secondary clock located on the removable card, the secondary clock configured to transmit the secondary clock signal through the otherwise unused pins; and
a clock-selection circuit configured to receive the main clock signal and the secondary clock signal, the clock-selection circuit further configured to detect presence of the secondary clock on the removable card, the clock-selection circuit further configured to output a secondary clock signal in response to detecting the presence of the secondary clock, the clock-selection circuit otherwise configured to output a main clock signal.

2. A clock source switching system comprising:
a main clock configured to generate a main clock signal;
a removable card having unused pins, the removable card configured to host a secondary clock, the secondary clock configured to generate a secondary clock signal, the removable card further configured to relay the secondary clock signal through the unused pins; and
a clock-selection circuit configured to receive the main clock signal and the secondary clock signal, the clock-selection circuit further configured to detect either presence of the secondary clock on the removable card, the clock-selection circuit further configured to output a secondary clock signal in response to detecting the presence of the secondary clock, the clock-selection circuit otherwise configured to output a main clock signal.

3. The system of claim 2, wherein the removable card is further configured to generate a clock-select signal indicative of either the presence or absence of the secondary clock.

4. The system of claim 3, wherein the clock-selection circuit comprises a phase-locked loop (PLL) circuit configured to receive the main clock signal, the secondary clock signal, and the clock-select signal indicative of either the presence or the absence of the secondary clock.

5. The system of claim 4, wherein the PLL circuit is further configured to output the main clock signal in response to the clock-select signal being indicative of the absence of the secondary clock, the PLL circuit further configured to output the secondary clock signal in response to the clock-select signal being indicative of the presence of the secondary clock.

6. The system of claim 3, wherein the clock-selection circuit comprises a multiplexer (MUX) configured to receive the main clock signal, the secondary clock signal, and the clock-select signal indicative of either the presence or the absence of the secondary clock.

7. The system of claim 6, wherein the MUX is further configured to output the main clock signal in response to the clock-select signal being indicative of the absence of the secondary clock, the MUX further configured to output the secondary clock signal in response to the clock-select signal being indicative of the presence of the secondary clock.

8. The system of claim 2, wherein the removable card is a memory card.

9. The system of claim 2, wherein the removable card is a video card.

10. The system of claim 2, wherein the removable card is a controller card.

11. The system of claim 2, wherein the removable card is an external card.

12. The system of claim 2, wherein the removable card is adapted for an expansion slot of a computer system.

13. A clock source switching system comprising:
a main clock configured to generate a main clock signal;
an input/output (I/O) slot configured to receive a peripheral device, the peripheral device having a secondary clock, the secondary clock configured to generate a secondary clock signal, the peripheral device configured to relay the secondary clock signal through the I/O slot; and
a clock-selection circuit configured to receive the main clock signal and the secondary clock signal, the clock-selection circuit further configured to detect presence of the secondary clock at the I/O slot, the clock-selection circuit further configured to output a secondary clock signal in response to detecting the presence of the secondary clock, the clock-selection circuit otherwise configured to output a main clock signal.

14. In an electronic assembly having a main clock and a pre-existing module having at least two unused pins, a clock source switching method comprising:
installing a secondary clock on the pre-existing module;
generating a secondary clock signal using the installed secondary clock; and
relaying the generated secondary clock signal through one of the at least two unused pins.

15. The method of claim 14, further comprising:
generating a clock-select signal from the installed secondary clock; and
relaying the generated clock-select signal through the other of the at least two unused pins.

16. In an electronic assembly having a main clock, a clock source switching method comprising:
detecting a secondary clock installed on a removable card having unused pins; and
selecting the secondary clock in response to detecting the secondary clock.

17. The method of claim 16, further comprising the step of selecting the main clock in response to failing to detecting the secondary clock.

18. In an electronic assembly having a main clock and a pre-existing module having at least two unused pins, a clock source switching system comprising:
means for generating a secondary clock signal from the pre-existing module; and
means for relaying the generated secondary clock signal through one of the at least two unused pins.

19. The system of claim 18, further comprising:
means for generating a clock-select signal from the pre-existing module; and
means for relaying the generated clock-select signal through the other of the at least two unused pins.

20. In an electronic assembly having a main clock, a clock source switching system comprising:
means for detecting a secondary clock installed on a removable card having unused pins; and
means for selecting the secondary clock in response to detecting the secondary clock.

21. The system of claim 20, further comprising means for selecting the main clock in response to not detecting the secondary clock.
